(19) United States
(12) Patent Application Publication
(10) Pub. No.: US 2008/0210061 A1
(43) Pub. Date: Sep. 4, 2008

(54) RATCHET WRENCH THAT IS MOUNTED CLOSELY

(76) Inventor: Hsiang-Chen Yu, Dali City (TW)

Correspondence Address: APEX JURIS, PLLC, 12360 LAKE CITY WAY NORTHEAST, SUITE 410, SEATTLE, WA, 98125, US

(21) Appl. No.: 11/681,542

(22) Filed: Mar. 2, 2007

(51) Int. Cl. B25B 13/22

(52) U.S. Cl. 81/58

(57) ABSTRACT

A ratchet wrench includes a wrench body, a ratchet wheel, and a drive device. The drive device includes a pawl member, a drive block, and a control button. Thus, the insert of the pawl member is inserted into the slot of the drive block so that the pawl member and the drive block are combined integrally, and the pawl member is limited in the head portion of the wrench body, so that the pawl member and the drive block are retained by the head portion of the wrench body to prevent the drive block and the control button from being detached from the head portion of the wrench body by the push force of the first elastic unit.

### BACKGROUND OF THE INVENTION

1. Field of the Invention

The present invention relates to a ratchet wrench, and more particularly to a ratchet wrench whose operation direction is changeable.

2. Description of the Related Art

A conventional ratchet wrench in accordance with the prior art shown in FIG. 1 comprises a wrench body 10, a ratchet wheel 11 mounted on the wrench body 10, a pawl member 18 pivotally mounted in the wrench body 10 and having a first side formed with a plurality of teeth 17 meshing with a surface of the ratchet wheel 11, a drive block 14 rotatably mounted on the wrench body 10 to control pivot movement of the pawl member 17 and having a top formed with a protrusion 15, a control button 12 mounted on the drive block 14 to rotate the drive block 14 and having a bottom formed with a recess 13 mounted on the protrusion 15 of the drive block 14, and a spring 16 biased between a second side of the pawl member 18 and a side of the drive block 14. In operation, when the drive block 14 is rotated by the control button 12, the spring 16 is movable on the pawl member 18 to push and pivot the pawl member 18 relative to the ratchet wheel 11 to change the contact position and direction of the pawl member 18 with the ratchet wheel 11 so as to change the operation direction of the ratchet wheel 11 and to change the operation direction of the ratchet wrench. However, the protrusion 15 of the drive block 14 is easily detached from the recess 13 of the control button 12, so that the control button 12 is easily detached from the wrench body 10, thereby causing inconvenience to the user in operation of the ratchet wrench.

### SUMMARY OF THE INVENTION

The present invention is to mitigate and/or obviate the disadvantage of the conventional ratchet wrench.

The primary objective of the present invention is to provide a ratchet wrench that is mounted closely without detachment.

Another objective of the present invention is to provide a ratchet wrench, wherein the insert of the pawl member is inserted into the slot of the drive block so that the pawl member and the drive block are combined integrally, and the pawl member is limited in the head portion of the wrench body, so that the pawl member and the drive block are retained by the head portion of the wrench body to prevent the drive block and the control button from being detached from the head portion of the wrench body by the push force of the first elastic unit.

In accordance with the present invention, there is provided a ratchet wrench, comprising: a wrench body; a ratchet wheel mounted on the wrench body; a drive device mounted on the wrench body and including: a pawl member pivotally mounted in the wrench body to mesh with the ratchet wheel and formed with an outwardly protruding insert; a drive block rotatably mounted on the wrench body to control pivot movement of the pawl member and having a periphery formed with a radially extending slot facing the pawl member to receive the insert of the pawl member; a control button mounted on the drive block to rotate the drive block.

Further benefits and advantages of the present invention will become apparent after a careful reading of the detailed description with appropriate reference to the accompanying drawings.

### BRIEF DESCRIPTION OF THE DRAWINGS

The above and other objects of the present invention will become readily apparent by reference to the following detailed description when considered in conjunction with the accompanying drawings wherein:

FIG. 1 is . . .

FIG. 1 is an exploded perspective view of a conventional ratchet wrench in accordance with the prior art;

FIG. 2 is an exploded perspective view of a ratchet wrench in accordance with the preferred embodiment of the present invention;

FIG. 3 is a side plan exploded view of the ratchet wrench as shown in FIG. 2;

FIG. 4 is a perspective assembly view of the ratchet wrench as shown in FIG. 2; and

FIG. 5 is a side plan cross-sectional view of the ratchet wrench as shown in FIG. 4.

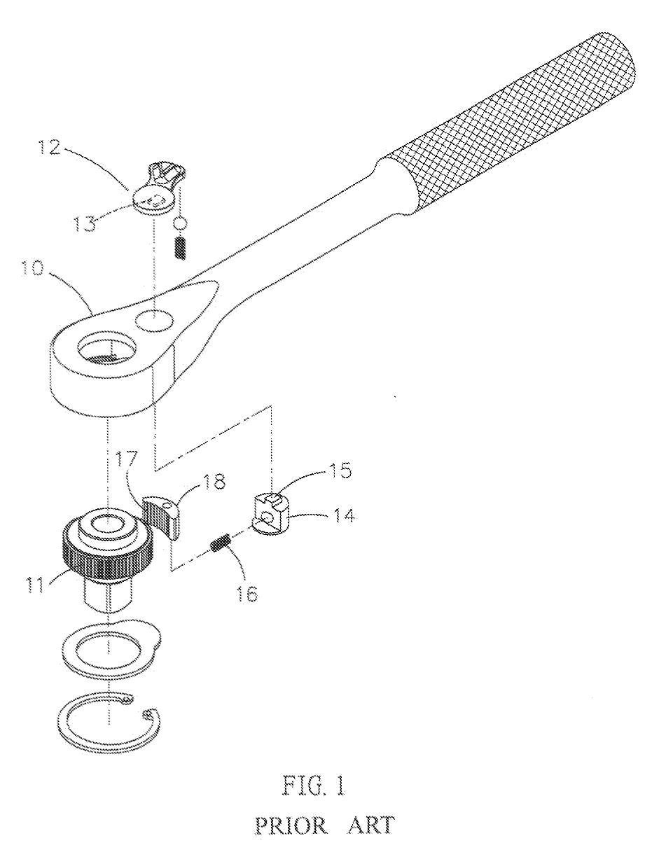

### DETAILED DESCRIPTION OF THE INVENTION

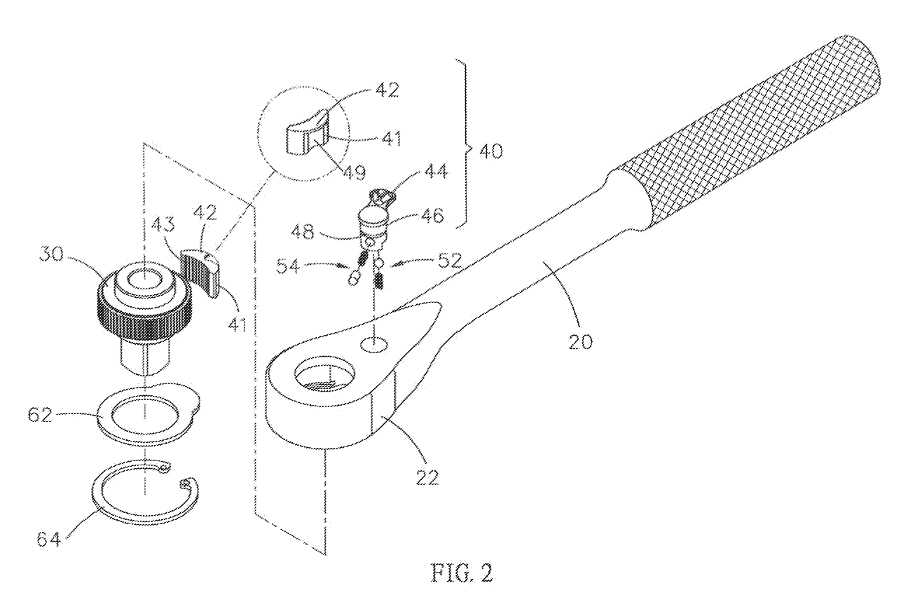

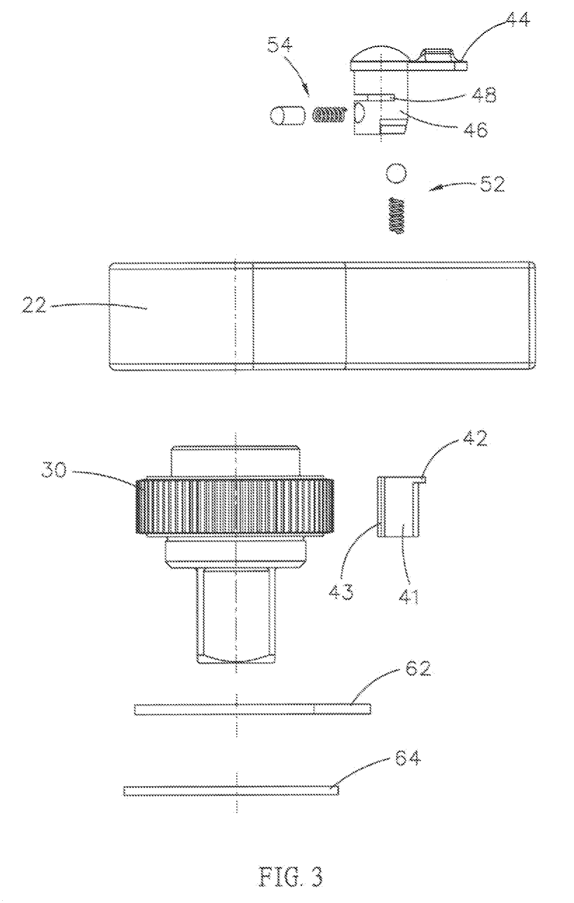

Referring to the drawings and initially to FIGS. 2 and 3, a ratchet wrench in accordance with the preferred embodiment of the present invention comprises a wrench body 20, a ratchet wheel 30 mounted on the wrench body 20, and a drive device 40 mounted on the wrench body 20.

The drive device 40 includes a pawl member 41 pivotally mounted in the wrench body 20 to mesh with the ratchet wheel 30 and formed with an outwardly protruding insert 42, a drive block 46 rotatably mounted on the wrench body 20 to control pivot movement of the pawl member 41 and having a periphery formed with a radially extending slot 48 facing the pawl member 41 to receive the insert 42 of the pawl member 41, and a control button 44 mounted on the drive block 46 to rotate the drive block 46.

The insert 42 of the pawl member 41 has a substantially arc-shaped profile and is directed toward a horizontal direction. The insert 42 of the pawl member 41 has a sheet shape. The drive block 46 has a column shape. The control button 44 is formed on and protruded outwardly from a first end of the drive block 46.

The pawl member 41 has a first side formed with a plurality of drive teeth 43 directed toward a direction opposite to that of the insert 42 and a second side opposite to the first side and having a middle position formed with a cavity 49 having an arc-shaped profile. The cavity 49 of the pawl member 41 is located under the insert 42 and directed toward a direction the same as that of the insert 42. The insert 42 of the pawl member 41 protrudes outwardly from the cavity 49.

The drive device 40 further includes a first elastic unit 52 axially mounted on the drive block 46 and a second elastic unit 54 radially mounted on the drive block 46. In the preferred embodiment of the present invention, each of the first elastic unit 52 and the second elastic unit 54 consists of a spring and a ball.

The wrench body 20 has an end portion formed with a head portion 22 to receive the ratchet wheel 30 and the drive device 40. The ratchet wrench further comprises a bottom cap 62 and a snap ring 64 mounted on a bottom of the wrench body 20 to retain the ratchet wheel 30 and the drive device 40 in the wrench body 20.

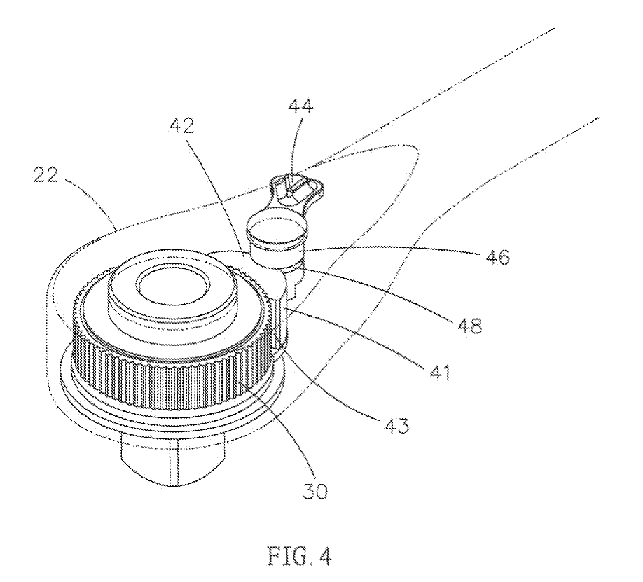

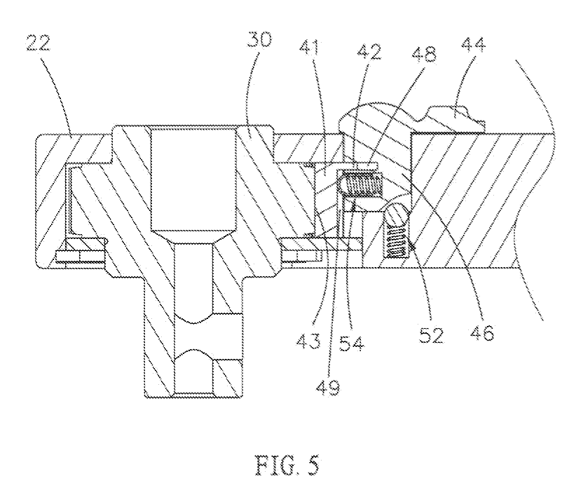

Referring to FIGS. 2-5, the drive teeth 43 of the pawl member 41 mesh with a surface of the ratchet wheel 30, and the insert 42 of the pawl member 41 is inserted into the slot 48 of the drive block 46. The first elastic unit 52 is biased between a second end of the drive block 46 and the head portion 22 of the wrench body 20 and is located opposite to the control button 44, and the second elastic unit 54 is biased between the periphery of the drive block 46 and the cavity 49 of the pawl member 41. The first elastic unit 52 and the control button 44 are located at two opposite ends of the drive block 46. The second elastic unit 54 is directed toward a direction parallel with and opposite to that of the control button 44, and the first elastic unit 52 is directed toward a direction perpendicular to that of the second elastic unit 54 and the control button 44.

Thus, the insert 42 of the pawl member 41 is inserted into the slot 48 of the drive block 46 so that the pawl member 41 and the drive block 46 are combined integrally, and the pawl member 41 is limited in the head portion 22 of the wrench body 20, so that the pawl member 41 and the drive block 46 are retained by the head portion 22 of the wrench body 20 to prevent the drive block 46 and the control button 44 from being detached from the head portion 22 of the wrench body 20 by the push force of the first elastic unit 52.

In operation, when the drive block 46 is rotated by the control button 44, the second elastic unit 54 is movable in the cavity 49 of the pawl member 41 to push and pivot the pawl member 41 relative to the ratchet wheel 30 to change the contact position and direction of the pawl member 41 with the ratchet wheel 30 so as to change the operation direction of the ratchet wheel 30 and to change the operation direction of the ratchet wrench.

Accordingly, the insert 42 of the pawl member 41 is inserted into the slot 48 of the drive block 46 so that the pawl member 41 and the drive block 46 are combined integrally, and the pawl member 41 is limited in the head portion 22 of the wrench body 20, so that the pawl member 41 and the drive block 46 are retained by the head portion 22 of the wrench body 20 to prevent the drive block 46 and the control button 44 from being detached from the head portion 22 of the wrench body 20 by the push force of the first elastic unit 52.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A ratchet wrench, comprising:
a wrench body;
a ratchet wheel mounted on the wrench body;
a drive device mounted on the wrench body and including:
a pawl member pivotally mounted in the wrench body to mesh with the ratchet wheel and formed with an outwardly protruding insert;
a drive block rotatably mounted on the wrench body to control pivot movement of the pawl member and having a periphery formed with a radially extending slot facing the pawl member to receive the insert of the pawl member; and
a control button mounted on the drive block to rotate the drive block.

2. The ratchet wrench in accordance with claim 1, wherein the insert of the pawl member has a substantially arc-shaped profile.

3. The ratchet wrench in accordance with claim 1, wherein the insert of the pawl member is directed toward a horizontal direction.

4. The ratchet wrench in accordance with claim 1, wherein the insert of the pawl member has a sheet shape.

5. The ratchet wrench in accordance with claim 1, wherein the drive block has a column shape.

6. The ratchet wrench in accordance with claim 1, wherein the pawl member has a first side formed with a plurality of drive teeth meshing with a surface of the ratchet wheel and directed toward a direction opposite to that of the insert and a second side opposite to the first side and having a middle position formed with a cavity.

7. The ratchet wrench in accordance with claim 6, wherein the cavity of the pawl member has an arc-shaped profile.

8. The ratchet wrench in accordance with claim 6, wherein the cavity of the pawl member is located under the insert.

9. The ratchet wrench in accordance with claim 6, wherein the cavity of the pawl member is directed toward a direction the same as that of the insert.

10. The ratchet wrench in accordance with claim 6, wherein the insert of the pawl member protrudes outwardly from the cavity.

11. The ratchet wrench in accordance with claim 6, wherein the drive device further includes a first elastic unit axially mounted on the drive block and a second elastic unit radially mounted on the drive block.

12. The ratchet wrench in accordance with claim 11, wherein each of the first elastic unit and the second elastic unit consists of a spring and a ball.

13. The ratchet wrench in accordance with claim 11, wherein the control button is formed on and protruded outwardly from a first end of the drive block.

14. The ratchet wrench in accordance with claim 13, wherein the first elastic unit is biased between a second end of the drive block and the wrench body and is located opposite to the control button.

15. The ratchet wrench in accordance with claim 11, wherein the second elastic unit is biased between the periphery of the drive block and the cavity of the pawl member.

16. The ratchet wrench in accordance with claim 11, wherein the first elastic unit and the control button are located at two opposite ends of the drive block.

17. The ratchet wrench in accordance with claim 11, wherein the second elastic unit is directed toward a direction parallel with and opposite to that of the control button.

18. The ratchet wrench in accordance with claim 17, wherein the first elastic unit is directed toward a direction perpendicular to that of the second elastic unit and the control button.

19. The ratchet wrench in accordance with claim 1, wherein the insert of the pawl member is inserted into the slot of the drive block so that the pawl member and the drive block are combined integrally, and the pawl member is limited in the wrench body, so that the pawl member and the drive block are retained by the wrench body to prevent the drive block and the control button from being detached from the wrench body.

20. The ratchet wrench in accordance with claim 1, wherein the wrench body has an end portion formed with a head portion to receive the ratchet wheel and the drive device.
